(19) United States
(12) Patent Application Publication
(10) Pub. No.: US 2007/0121776 A1
(43) Pub. Date: May 31, 2007

(54) System and method for multiple usage tooling for pressurized water reactor

(75) Inventor: Hsueh-Wen Pao, Santa Clara County, CA (US)

Correspondence Address: HARNESS, DICKEY & PIERCE, P.L.C., P.O. BOX 8910, RESTON, VA, 20195, US

(73) Assignee: General Electric Company

(21) Appl. No.: 11/289,555

(22) Filed: Nov. 30, 2005

(51) Int. Cl. G21C 9/00

(52) U.S. Cl. 376/305

(57) ABSTRACT

A system and method for inspecting, repairing and mitigating stress corrosion cracking on a pressure water reactor vessel. The reactor vessel includes inlet nozzles, outlet nozzles, and bottom mounted instrumentations. The method may include removing core barrels in the reactor vessel, installing a radiation shield in the reactor vessel, installing a coffer dam, draining the reactor vessel, lowering a tooling delivery robot into the reactor vessel, attaching the tooling delivery robot at a surface of the reactor vessel, lowering a tool cradle into the reactor vessel, and attaching the tool cradle at the surface of the reactor vessel.

### BACKGROUND OF INVENTION

1. Field of the Invention

This invention relates generally to tools for inspecting, repairing and mitigating stress corrosion cracking on pressure water reactor vessels.

2. Description of Related Art

A reactor pressure vessel (RPV) of a pressurized water reactor (PWR) typically has a generally cylindrical shape and is closed at both ends, e.g., by a bottom head and a removable top head.

At various times during the operational life of a nuclear reactor, there is a need to remove the core and internals from the reactor vessel via the top head. Such instances include refueling, inspecting, annealing, repairing and mitigation of stress corrosion cracking (SCC).

SCC is a known phenomenon occurring in reactor components, such as structural members, piping, fasteners, and welds which are exposed to high temperature water. The reactor components may be subject to a variety of stresses. These stresses may be associated with, for example, differences in thermal expansion, the operating pressure needed for the containment of the reactor cooling water, and other stress sources, such as residual stresses from welding, cold working and other inhomogeneous metal treatments. In addition, water chemistry, welding, heat treatment and radiation can influence the susceptibility of metal in a component to SCC.

Reactor components in contact with reactor coolant may occasionally be replaced as a result of failure due to SCC. Replacing the internal components typically may require removing the core internals from the reactor vessel. For example, in the event a safe end and interconnecting coolant pipes require replacement, the reactor must be shut down for maintenance and drained to an elevation below that of the nozzle safe end. The safe end and/or interconnecting coolant pipes are then removed and a replacement safe end and/or interconnecting coolant pipes are welded to the RPV nozzle. Replacing a safe end and/or interconnecting coolant pipes is typically time consuming and costly since such replacement generally requires a lengthy reactor outage.

During reactor operations, however, circumferential weld joints may experience intergranular stress corrosion cracking (IGSCC) and irradiation-assisted stress corrosion cracking (IASCC) in weld heat affected zones which can diminish the structural integrity of the reactor components.

Known methods of inspecting the circumferential welds for IGSCC and IASCC have utilized ultrasonic probes positioned on the outer surface at the weld joint. A series of scans are performed while projecting the ultrasonic beam through the weld from the outer side of the component to the inner side of the component. Other methods rely on positioning an ultrasonic or eddy current probes on the inner surface of the component and projecting the ultrasonic beam from the inner surface of the component toward the outer surface of the component. In any event, most methods for inspection require temporarily shut down of the reactor vessel.

Further, in order to apply corrosion resistance cladding (CRC) to reactor components, the reactor must be kept dry during welding process. In this event, it is required to drain a refueling pool in the reactor to keep the welding area dry. However, the refueling pool may be difficult to drain because the high dose reactor components are stored inside the pool with the reactor vessel open to the pool at the same time.

Accordingly, a need exists for reliable and relatively easy temporarily shielding and access to the internals of the reactor vessel, allow the reactor vessel to be drained of water, and provide a safe work place for personnel.

### SUMMARY OF THE INVENTION

Exemplary embodiments of the present invention relate to a system for shielding high radiation dose from inside reactor vessel wall and attached components. The system may include a radiation shield positioned within the reactor vessel, and a coffer dam. The radiation shield reduces the radiation dose from irradiated vessels. The coffer dam allows draining of the vessel and keeps the refueling pool filled with water.

Another exemplary embodiment provides the coffer dam with a working deck, and a coffer dam support for supporting the working deck. The working deck may include a rotatable access lid. The rotatable access lid may include a plurality of openings to access the interior of the reactor vessel.

Exemplary embodiments of the present invention provide a method of preparation of reactor vessel for services. The method may include removing core barrels in the reactor vessel, installing a radiation shield in the reactor vessel, installing a coffer dam, and draining the reactor vessel.

Exemplary embodiments of the present invention related to a system for inspecting, repairing and mitigating stress corrosion cracking on a pressure water reactor vessel. The reactor vessel includes inlet nozzles, outlet nozzles, and bottom mounted instrumentation (BMI) nozzles. The system may include a radiation shield positioned within the reactor vessel, a coffer dam, a tooling delivery robot lowered into the reactor vessel, and a tool cradle for holding the tools.

Exemplary embodiments of the present invention relate to a method for inspecting, repairing and mitigating stress corrosion cracking on a pressure water reactor vessel. The method may include removing core barrels in the reactor vessel, installing a radiation shield in the reactor vessel, installing a coffer dam, draining the reactor vessel, lowering a tooling delivery robot into the reactor vessel, attaching the tooling delivery robot at a surface of the reactor vessel, lowering a tool cradle which hold tools into the reactor vessel, and attaching the tool cradle at the surface of the reactor vessel.

### BRIEF DESCRIPTION OF THE DRAWINGS

Exemplary embodiments of the present invention will become more apparent by describing, in detail, exemplary embodiments thereof with reference to the attached drawings, wherein like procedures are represented by like reference numerals, which are given by way of illustration only and thus do not limit the present invention.

FIG. 1 is a schematic view of a reactor pressure vessel in accordance with an exemplary embodiment of the present invention.

FIG. 2 is a schematic view of a reactor pressure vessel with core barrels removed in accordance with an exemplary embodiment of the present invention.

FIG. 3A is a schematic view of a radiation shielding in accordance with an exemplary embodiment of the present invention.

FIG. 3B is a schematic view of a radiation shielding installed in the reactor vessel in accordance with an exemplary embodiment of the present invention.

FIG. 4 is a schematic view of a coffer dam installed on the reactor pressure vessel in accordance with an exemplary embodiment of the present invention.

FIG. 5 is a schematic view of the working deck in accordance with an exemplary embodiment of the present invention.

FIG. 6 is a schematic view of a reactor pressure vessel and a filter in accordance with an exemplary embodiment of the present invention.

FIG. 7 is a schematic view of a bottom vessel wall with internal components in accordance with an exemplary embodiment of the present invention.

FIG. 8 is a flowchart illustrating the installation of tooling delivery robots in accordance with an exemplary embodiment of the present invention.

### DETAILED DESCRIPTION OF EXEMPLARY EMBODIMENTS

It should be noted that these Figures are intended to illustrate the general characteristics of method and apparatus of exemplary embodiments of the present invention, for the purpose of the description of such exemplary embodiments herein. These drawings are not, however, to scale and may not precisely reflect the characteristics of any given embodiment, and should not be interpreted as defining or limiting the range of values or properties of exemplary embodiments within the scope of this invention. Like numerals are used for liked and corresponding parts of the various drawings.

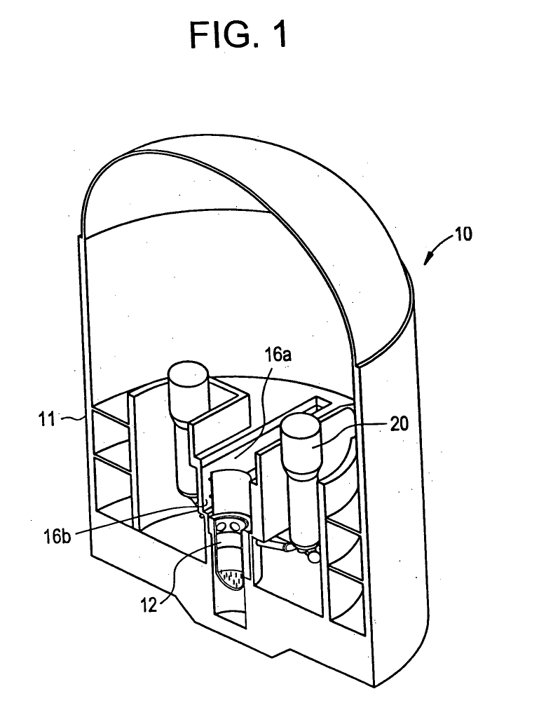

FIG. 1 is a schematic view of a reactor pressure vessel in accordance with an exemplary embodiment of the present invention. In particular, FIG. 1 illustrates a perspective view of the containment building 10 with a cutaway of a containment wall 11 to show a reactor vessel 12, refueling pool 16a and reactor pool 16b therein. The reactor vessel 12 is an elongated, generally cylindrically shaped member. The reactor vessel 12 has the usual hemispherical bottom and a plurality of inlet and outlet primary system water nozzles. As an exemplary embodiment, the inlet nozzle may introduce coolant pumps into reactor vessel to cool the reactor's core which creates heat, and the outlet nozzle discharges heated pressurized-water in a primary coolant loop to carry the heat to a steam generator 20. The steam generator 20 vaporizes the water in a secondary loop to drive the turbine (not shown), which then ultimately produces electricity.

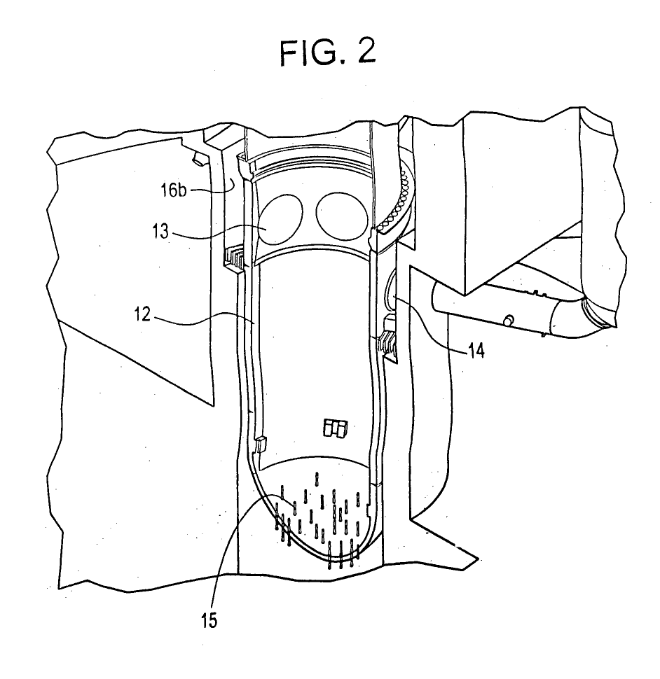

FIG. 2 is a schematic view of a reactor pressure vessel with core barrels removed in accordance with an exemplary embodiment of the present invention. As shown in FIG. 2, a closure head of the vessel reactor 12 and fuel (not shown) are removed. Further, radioactive lower and upper internals have been removed and stored. The reactor vessel 12 may include inlet nozzles 13 for inlet of coolant and outlet nozzles 14 for outlet of hot-pressurized water to produce energy for steam generators 20 (as shown in FIG. 1). The reactor vessel 12 further includes bottom mounted instrumentation nozzles 15 (BMI). The BMI nozzles 15 are penetrated tube attached to the bottom head of the vessel 12. The BMI nozzles 15 may be welded (via a J-groove weld, for example) to the vessel 12.

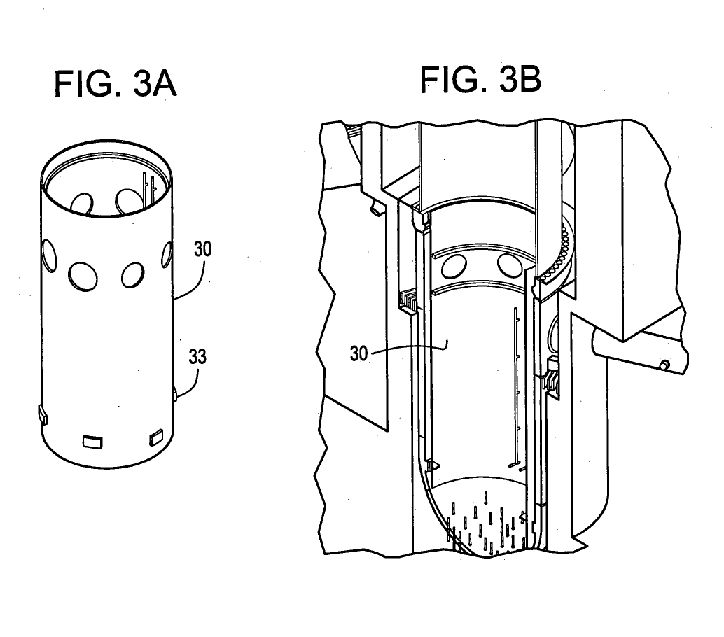

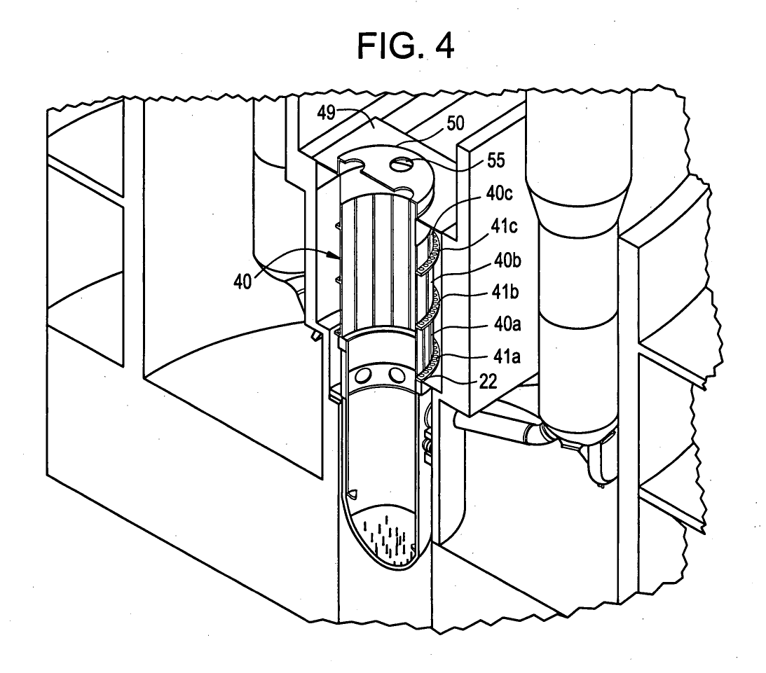

Before performing an inspection, repair and/or mitigation for stress corrosion cracking (SCC) in the containment building 10, precautions must be taken to prevent radiation emitted by the stored internals from being introduced to humans. In this regard, temporary radiation shielding 30 (shown in FIG. 3A and 3B) of the stored internal should be employed, and coffer dams 40 (shown in FIG. 4) assembled on the reactor vessel 12 to seal the interior of vessel from water in refueling pool 16a and reactor pool 16b.

FIG. 3A is a schematic view of a radiation shield 30 in accordance with an exemplary embodiment of the present invention; and FIG. 3B is a schematic view of a radiation shield 30 installed in the reactor pressure vessel in accordance with an exemplary embodiment of the present invention. One of the purposes served by the radiation shield 30 is to minimize radiation dose from the irradiated vessel 12.

The radiation shield 30 is generally cylindrical which conforms to shape of the reactor vessel 12. In other words, the circumference of the radiation shield 30 should closely resemble the inner circumference of the reactor vessel 12. The radiation shield 30 includes a plurality of openings 31 near the top end to correspond with nozzles 13 in the reactor pressure vessel 12. It should be appreciated that the openings 31 may be varied depending on the number and size of corresponding nozzles found in the pressure vessel 12. The radiation shield 30 may include notches 33 on an exterior surface of the shield 30. The notches 33 provide support for the radiation shield 30 when positioned on internal brackets (not shown) in the vessel 12. The notches 33 may also act as a locating means for locating the position of the radiation shield 30 while positioned within the reactor vessel 12. The radiation shield 30 may be made from steel. However, one skilled in the art would appreciate that other metals, such as, but not limited to, stainless steel, may be employed.

It should be appreciated that the design of the radiation shield 30 may be varied depending on, for example, but not limited to, shape of the reactor vessel, radiation measurement, and thermal data.

Once the radiation shield 30 is installed in the reactor vessel 12, a coffer dam may be installed on the reactor vessel to provide temporary shielding, and designed to allow draining of the vessel and keep the refueling pool and reactor pool filled with water. The structure of the coffer dam will now be described with reference to FIG. 4, wherein the coffer dam is generally referred to by reference number 40.

FIG. 4 illustrates a schematic view of a coffer dam 40 installed on the reactor pressure vessel 12 in accordance with an exemplary embodiment of the present invention.

The coffer dam 40 is generally cylindrical and includes a plurality of segments 40a, 40b, 40c . The plurality of segments 40a, 40b, 40c may be sealed via sealing means (not shown) positioned between fit up flanges or edges 41a, 41b, 41c, of adjacent segments 40a, 40b, 40c. Fasteners (not shown) may be included for attaching together the edges 41a, 41b, 41c of adjacent segments 40a, 40b, 40c. Further, sealing means (not shown) may be positioned between the bottom flange 41a of the completed coffer dam 40 and the reactor vessel upper flange 22; and fasteners (not shown) may be used for attaching the bottom flange 41a to the reactor vessel upper flange 22.

Each segment 40a, 40b, 40c is an elongated vertical cylindrical section, (e.g., each segment is an equal longitudinal curved section of the total cylindrical coffer dam). If four segments are used, each segment may be curved 90 degrees; if three segments, 120 degrees; and so on. In an alternate embodiment, each segment 40a, 40b, 40c may be a horizontal cylindrical section (e.g., each segment is a cross sectional portion of the cylinder).

Further, if desired, the coffer dam 40 can be made of a combination of vertical and horizontal sections connected together.

In any case, the size of the segments of the coffer dam 40 is selected so as to fit through an equipment hatch (not shown) of the containment building 10 and yet still correspond to the size of the reactor vessel 12. In other words, the circumference of the segment should closely resemble the inner circumference of the reactor vessel 12. The choice size and quantity of the segments of the coffer dam 40 can also be varied to satisfy other manufacturing, transport and plant specific conditions.

Each segment 40a, 40b, 40c includes vertical and horizontal fit up flanges or edges 41a, 41b, 42c. The adjacent edges 41a, 41b, 42c are mated and connected by fasteners, such as bolt and nut combinations, for example. The lowermost set of horizontal fit up flanges or edges 41a may form the bottom flange of the completed coffer dam 40, whereas the uppermost set of horizontal fit up flanges or edges 41c may form the upper flange of the coffer dam 40.

Each of the segments 40a, 40b, 40c may be pre-fabricated to contain the sealing means described below. Alternatively, all or some of the sealing means could be installed when the segments 40a, 40b, 40c are being assembled on the operating floor. In an example embodiment, the sealing means may be a thermal insulator gasket-type seal in combination with metallic and non-metallic 0-rings. The sealing means helps resolve a significant feasibility issue by allowing a plurality of segments 40a , 40b, 40c to be passed through the hatch and to form the complete coffer dam 40. In order to prevent any leakage through the joint with sealing features, the space formed between two sealing device can be pressurized to prevent and/or reduce any coolant leak into the dry reactor vessel.

Once the segments 40a, 40b, 40c are connected together to form the completed coffer dam 40, the coffer dam 40 is moved and attached to the reactor vessel flange 22.

The bottom flange 41a of the coffer dam 40 may be connected to the reactor vessel flange 22 via fasteners (not shown), for example, but not limited to, a threaded bolt arrangement. More particularly, the bottom flange 32 of the coffer dam 40 may have a plurality of holes to allow the completed coffer dam 40 to be bolted to the threaded holes formed in the reactor vessel 12 for receiving the closure head. This bolt down arrangement prevents a catastrophic seal failure because the flanges 41a-41c are in intimate contact.

Accordingly, with the coffer dam 40 installed on the reactor vessel 12, a temporary shield to reduce and/or prevent radiation emitting from the stored internals is provided and/or to allow draining of the reactor vessel 12 and keep the refueling pool filled with water.

It should be appreciated that the segments 40a, 40b, 40c can be pre-fabricated in a factory or each segment may be brought into the containment building 10 and preferably assembled by humans in a low radiation area of the operating floor.

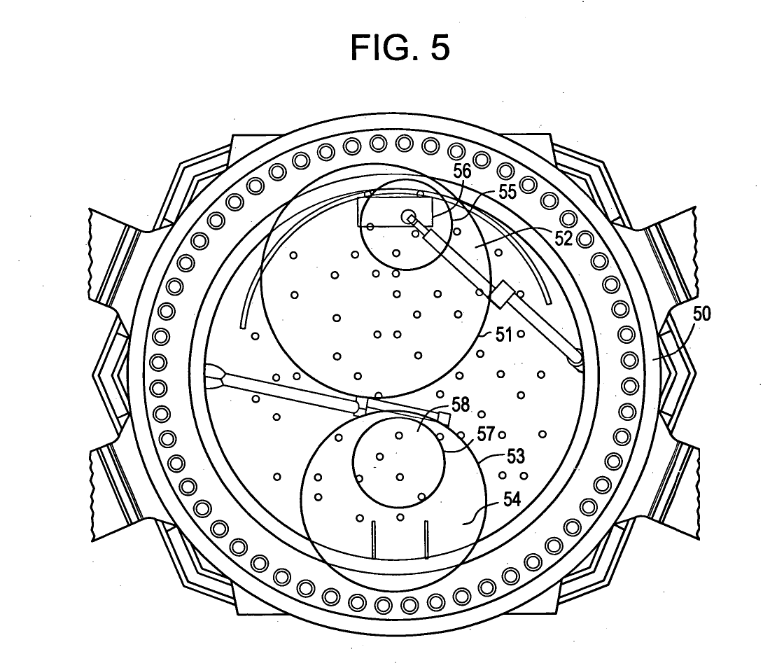

On top of the coffer dam 40 is a working deck 50, in which the coffer dam 40 is mounted on a supporter 49 as shown in FIG. 4. The working deck 50 may include a plurality of access holes 51, 53 (shown in FIG. 5) for accessing the interior of the reactor vessel 12 by a user. For example, the access holes 51, 53 may be used to inspect/repair any nozzles in the bottom head of the vessel and/or nozzles in the side surface of the vessel. The access holes 51, 53 may provide ease in maintenance, repair, inspection and mantling/dismantling of parts from inside of the reactor vessel 12.

Referring further to FIG. 5, the working deck 50 includes two large access openings 51, 53 for large tools to enter the vessel 12. The large access openings 51, 53 accommodate large plugs 52, 54, respectively, which may be removable from the access openings. The size of plug 52 may be ½ of the size of the inside diameter of reactor vessel 12. As a result, this would allow instruments to reach the center of the reactor and/or near the edge of the reactor. The size of plug 54 may be determined by a particular tool size as it is designed for tooling access from above the working deck 50 into the reactor vessel 12. However, it should be appreciated that the size of the plugs 52, 54 and the openings 51, 53 may vary depending on the operation required. The large plug 52 may further include a small opening 55 for smaller tool access. The small opening 55 may include a removable small plug 56 to be inserted therein. The removable small plug 56 may be, for example 8 inch to 16 inch in diameter. However, it should be appreciated that other diameter size may be employed depending on the size of the tools employed. Similarly, the small plug 54 may include a small opening 57 for tool access. The small opening 57 may include a removable small plug 58 to be inserted therein.

The working deck 50 rotates (e.g., 360 degrees) with respect to the coffer dam 40. Further, it should be appreciated that the large plug 52 and the small plug 54 rotate within their respective openings. As a result, accessing of parts in the reactor vessel 12 may be easily handled and manipulated.

Referring back to FIG. 4, the working deck 50 is introduced through the equipment hatch (not shown) in the containment building 10. The working deck 50 may be secured to the coffer dam support 49 by fasteners and with rotating mechanism (not shown).

Further, the working deck 50 may rotate 360 degrees to operate in tandem with a transport robot which will be described later. The rotation of the working deck 50 provides an ease in lowering and retrieving an application robot that is configured for inspection, repair, welding and/or machine operation.

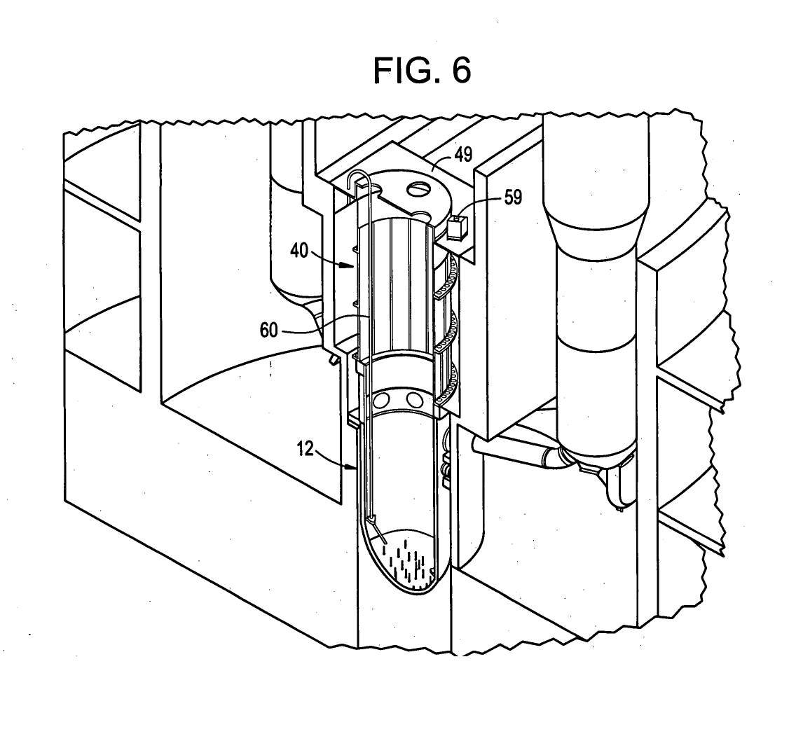

Referring to FIG. 6, the coffer dam 40 according to an exemplary embodiment of the present invention may include a filter 59 for effective control of airborne particles in the reactor vessel 12. The filter 59 is positioned on the coffer dam support 49 near the access opening. It should be appreciated that the filter 59 may also be located on the operating floor. Flexible ventilation duct may be connected from the access opening to an inlet port of filter 59.

Further, in order to keep the vessel drain without airborne issues, the filter 59 may maintain a negative pressure inside the vessel 12 in operation. The negative pressure inside the vessel 12 may prevent airborne spreading to the operating floor and minimize contamination.

As an example embodiment, the filter 59 may be a high efficiency particulate air (HEPA) filter.

Once the temporary radiation shield 30 and the coffer dam 40 are installed in the reactor vessel 12 and the HEPA filter 59 operating, the vessel is drained of all fluid. The reactor vessel 12 may be drained by lowering a pump (not shown) into the vessel via the access openings 55, 57 in the working deck 50, as shown in FIG. 5. The drainage operation is continued until the vessel is dry.

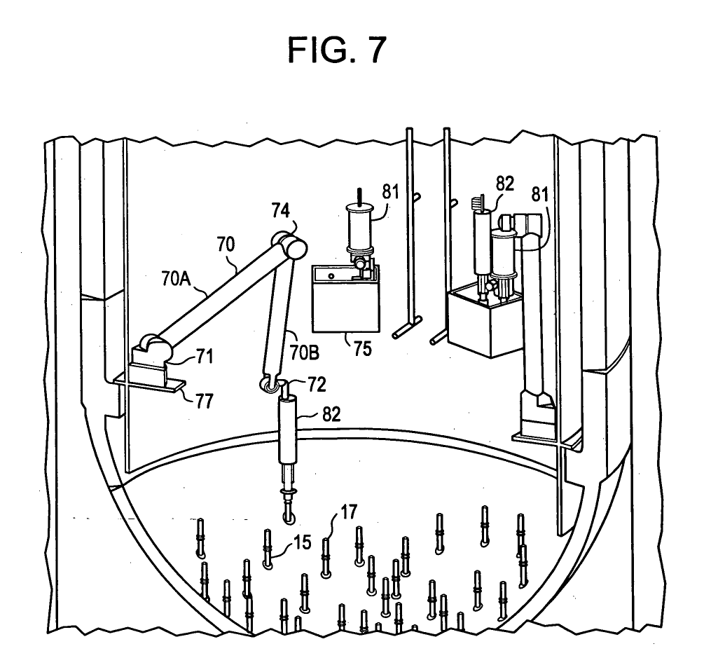

Once the vessel is completely dry, protectors 17 (shown in FIG. 7) are installed on all bottom mounted instrumentation (BMI) nozzles 15. The protectors 17 are used to protect the BMI 15 surface from damage by the mounted tooling on top of BMI 15. Further, the design of the protectors 17 may be employed to engage with the tools for inspecting, repairing, and/or mitigating SCC.

Once the protectors 17 are installed on the BMI 15, the operation proceeds to preparation of cleaning the internals of the reactor vessel 12 as described below.

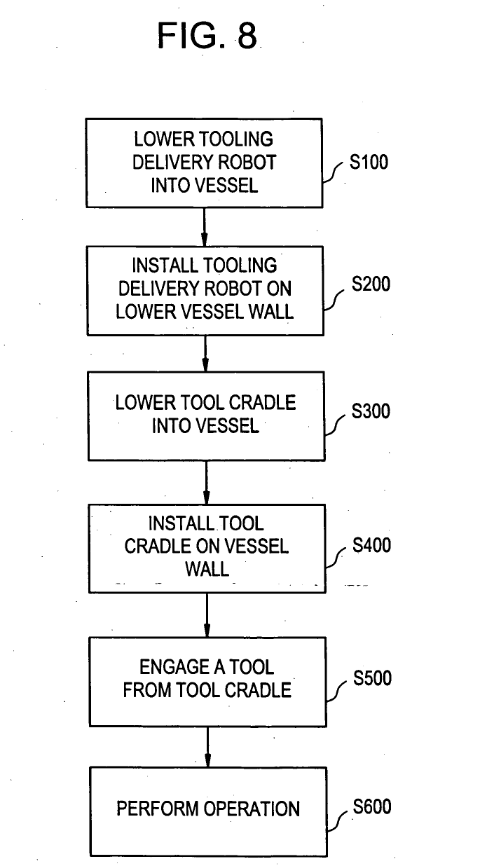

FIG. 8 is a flowchart illustrating the installation of tooling delivery robots in accordance with an exemplary embodiment of the present invention.

To perform the operation, a tooling delivery robot is lowered into the reactor vessel (S100), and installed at a surface of the vessel wall (or vessel bracket) (S200). A tool cradle which holds the tools for operating is then lowered into the vessel (S300), and affixed at the surface of the vessel wall (S400). Thereafter, the delivery robot moves toward the tool cradle and engages a cleaning tool from the tool cradle (S500). The delivery robot then moves away from the tool cradle along with the tool, and commences the operation (S600).

Referring back to FIG. 7, the tooling delivery robot 70 and tooling cradle 75 in the reactor vessel 12 are shown in accordance with an exemplary embodiment of the present invention.

The tooling delivery robot 70 is lowered into the reactor vessel 12 to be installed. The tooling delivery robot 70 may be lowered using, for example, but not limited to, jig hoist, ropes and/or poles. The lowering of the tooling delivery robot 70 may also work in tandem with the rotating working deck 50 to position the delivery robot 70 in the appropriate position. In other words, the tooling delivery robot 70 may be lowered via openings 51, 53 in the working deck 50, wherein the working deck 50 rotates so as to provide ease in positioning the tooling delivery robot 70 in the reactor vessel 12 for installation.

The tooling delivery robot 70 may be typically comprised of two segment arms 70A, 70B. Segment arm 70A is interposed between a connection means 71 and an end of segment arm 70B. Segment arm 70B is interposed between an end of segment arm 70A and a tool connector 72. One end of each segment arms 70A and 70B are rotatable at a connection joint 74. The arms 70A, 70B may rotate 360 degrees. Further, the tooling delivery robot 70 may provide the necessary translation movement to cover the entire bottom area of the reactor vessel 12.

It should be appreciated that more than two segments may be employed to make up the tooling delivery robot depending on the angles and positions required for the robot arm.

Once the tooling delivery robot 70 is lowered, the connection means 71 is mounted to a small platform 77 attached at the surface of the vessel wall. The connection means 71 may be fastened to the platform 77 using, for example, but not limited to, nuts and bolts.

The tool cradle 75 is then lowered into the reactor vessel 12. The tool cradle 75 may include tools, such as, a weld held tool 81 for repairing SCC and a surface improvement tool 82 for cleaning SCC, for example. However, it should be appreciated that other tools may be included in the tool cradle depending on the operation desired.

Once the tooling cradle 75 is positioned and installed in the vessel 12, the tooling delivery robot 70 moves to engage with a tool in the tool cradle 75. As an exemplary embodiment, if the operation is to mitigate the SCC in the BMI 15, the tool delivery robot 70 engages with the tool weld head 81 and performs the repairing operation on the BMI 15.

It should be appreciated that other tools may be employed besides the tool weld head to perform other operations, such as, inspecting, cleaning, repairing and/or machining.

As shown in FIG. 7, two tooling delivery robots 70 and two tool cradles 75 are provided in the reactor vessel 12. The two tooling delivery robots 70 should provide sufficient movement and coverage in the reactor vessel 12 to cover the entire BMI 15 locations. In other words, the tooling delivery robots 70 operate to guide the tools 80 for inspection, repair, welding and/or machine tooling for all of the BMIs 15.

Further, the tooling delivery robots 70 may provide the ability to perform different IGSCC mitigation functions simultaneously. For example, a first tooling delivery robot may perform at least one of inspecting, welding and machining operation simultaneously in different BMI to create a parallel path work flow, while simultaneously, a second tooling delivery robot 70 may retrieve the tools when the first tooling robot delivery have completed its tasks.

The exemplary embodiments of the present invention being thus described, it will be obvious that the same may be varied in many ways. Such variations are not to be regarded as departure from the spirit and scope of the exemplary embodiments of the present invention, and all such modifications as would be obvious to one skilled in the art are intended to be included within the scope of the following claims.

1. A system for shielding stored internals in a reactor vessel, comprising:
a radiation shield positioned within the reactor vessel;
a coffer dam positioned above the radiation shield, and
a working deck having an access lid, the access lid being rotatable with respect to the coffer dam.

2. The system according to claim 1, wherein the radiation shield includes openings, the openings conform with nozzles in the reactor vessel.

3. The system according to claim 2, wherein the radiation shield has a circumference which matches an inner circumference of the reactor vessel.

4. The system according to claim 1, wherein the coffer dam is segmented into a plurality of pieces.

5. The system according to claim 4, wherein the coffer dam is segmented into three pieces.

6. The system according to claim 1, wherein the coffer dam further comprising
a coffer dam support for supporting the coffer dam and working deck.

7. The system according to claim 6, wherein the access lid includes a plurality of openings to access an interior of the reactor vessel.

8. (canceled)

9. The system according to claim 1, further comprising a filter disposed on a coffer dam support for removing airborne particles.

10. A method of cleaning internals of a reactor vessel, comprising:
removing core barrels in the reactor vessel;
installing a radiation shield in the reactor vessel;
installing a coffer dam; and
draining the reactor vessel.

11. The method according to claim 10, wherein the installation of the coffer dam further comprises:
providing a working deck; and
installing a coffer dam support for supporting the working deck.

12. The method according to claim 11, wherein the working deck includes an access lid, the access lid including a plurality of openings to access the interior of the reactor vessel.

13. The method according to claim 12, wherein the access lid is rotatable.

14. The method according to claim 10, further comprising installing a filter for ventilating airborne particles in the reactor vessel.

15. The method according to claim 10, further comprising installing protectors for bottom mounted instrumentations.

16. A system for inspecting, repairing and mitigating stress corrosion cracking on a pressurized water reactor vessel, the reactor vessel including inlet nozzles, outlet nozzles, and bottom mounted instrumentations, comprising:
a radiation shield positioned within the reactor vessel;
a coffer dam; positional above the radiation shield
a working deck having an access lid, the access lid being rotatable with respect to the coffer dam;
a tooling delivery robot lowered into the reactor vessel via the access lid; and
a tool cradle for holding tools.

17. The system according to claim 16, wherein the coffer dam further comprising
a coffer dam support for supporting the working deck.

18. The system according to claim 17, wherein the rotatable access lid rotates while the tooling delivery robot is lowered into the reactor vessel.

19. The system according to claim 16, wherein the tooling delivery robot engages with the tools to inspect, repair and mitigate stress corrosion cracking in the reactor vessel.

20. The system according to claim 16, wherein the tools is one of a surface improvement tool and a welding machine.

21. The system according to claim 16, wherein more than one tooling delivery robot is lowered into the vessel to cover the area of the bottom mounted instrumentations.

22. A method for inspecting, repairing and mitigating stress corrosion cracking on a pressurized water reactor vessel, the reactor vessel including inlet nozzles, outlet nozzles, and bottom mounted instrumentations, comprising:
removing core barrels in the reactor vessel;
installing a radiation shield in the reactor vessel;
installing a coffer dam;
draining the reactor vessel;
lowering a tooling delivery robot into the reactor vessel;
attaching the tooling delivery robot at a surface of the reactor vessel;
lowering a tool cradle holding tools into the reactor vessel; and
attaching the tool cradle at the surface of the reactor vessel.

23. The method according to claim 22, wherein the installation of the coffer dam further comprises:
providing a working deck; and
installing a coffer dam support for supporting the working deck.

24. The method according to claim 23, wherein the working deck includes an access lid, the access lid including a plurality of openings to access the interior of the reactor vessel.

25. The method according to claim 24, further comprising rotating the access lid while lowering the tooling delivery robot into the reactor vessel.

26. The method according to claim 22, wherein the tooling delivery robot engages with the tools in the tool cradle to inspect, repair and mitigate stress corrosion cracking in the reactor vessel.

27. The method according to claim 22, wherein more than one tooling delivery robot is lowered into the vessel to cover the area of the bottom mounted instrumentations.

28. The system according to claim 17, wherein to access lid includes a plurality of openings to access an interior of the reactor vessel.
